(19) United States
(12) Patent Application Publication
(10) Pub. No.: US 2015/0193492 A1
(43) Pub. Date: Jul. 9, 2015

(54) EDITING SUB-SECTION OF AN ELECTRONIC DOCUMENT VIA NOTIFICATION MESSAGE

(71) Applicant: Google Inc., (US)

(72) Inventors: Junius Gunaratne, Brooklyn, NY (US); Vance Julius Vagell, Kew Gardens, NY (US); Shoshana Holtzblatt, New York, NY (US); Micah Lemonik, Great Neck, NY (US)

(73) Assignee: GOOGLE INC., Mountain View, CA (US)

(21) Appl. No.: 13/672,521

(22) Filed: Nov. 8, 2012

(51) Int. Cl. G06F 17/30; G06F 21/62

(52) U.S. Cl. CPC G06F 17/30345; G06F 21/6218

(57) ABSTRACT

Systems and methods are disclosed herein for collaboratively editing a sub-section of an electronic document through a notification message. The systems and methods may be used for collaboration among multiple users, each user having a respective level of access to the electronic document and contributing content to respective sub-sections of the electronic document. A selection of the electronic document is received from a first user requesting the selection to be updated by a second user. A notification message including the selection of the electronic document is sent to the second user. A modification of the electronic document is then received from the second user in response to the second user modifying the selection of the electronic document from within the notification message. The electronic document is updated with the modification received from the second user.

### FIELD OF INVENTION

In general, this disclosure relates to electronic documents, in particular, to systems and methods for collaboratively creating and/or editing an electronic document.

### BACKGROUND

The creation of a collaborative electronic document may sometimes require the contribution of content by multiple different users to different sub-sections of an electronic document. It can be challenging to coordinate the addition of new content as the multiple users may not readily know what part of the electronic document they are allowed to view and/or edit or how the multiple users are expected to contribute to the document. For example, the users may not know whether they are supposed to review, edit, delete, comment, and/or expand upon the content of a collaborative electronic document. In some cases, it may even be undesirable to let the users to edit or view any part of the document for which they are not responsible. In the current art, an editor can create a skeleton of an electronic document and solicit input from each contributing user to the skeleton document. There can be different ways to solicit an input from the contributing users.

One way of soliciting input may involve copying a sub-section of the skeleton document into a notification message and sending the notification to a collaborating user. The notification message may also include a request for the contributing user to modify the copied content. The contributing user can modify the sub-section and send a notification message to the editor with the modified sub-section. In response, the editor can integrate the modifications into the electronic document. However, this would require the editor to manually merge all the contributions to the electronic document. This merging process can be especially tedious if multiple collaborating users contribute to the same section of the document. The content received from the multiple collaborators may not be mutually exclusive and may require de-duplication and/or re-ordering by the editor.

To solve the issue of merging content, input can also be solicited in a collaborative editing environment where an editor can send instructions to the different collaborating users via a notification message. The instructions may include a reference to the location of a sub-section of a skeleton document and a description of the content needed. Each of the contributing users can access the document and modify it according to the instructions in the notification message. This allows the contributing users to be able to see the changes as they are made and they can provide their input based on the state of the document when they access it. However, this process can be manual and tedious as the editor may have to communicate with multiple different contributing users, manually reference different parts of the skeleton document to which the users may add content, and/or integrate the inputs from the different users. Due to the collaborative nature of electronic documents, the manual references may become outdated as the skeleton document is changed over time. It is also possible for the users collaborating on the skeleton document to make changes to sub-sections of documents that the editor may not have intended for them to change, thereby introducing errors to the skeleton document. This manual nature of requesting edits to different sub-sections of an electronic document may therefore introduce errors and ambiguity into the collaborative process of editing the electronic document.

### SUMMARY

The systems and methods described herein can be used to avoid such ambiguities and to improve the collaboration process. In one aspect, an editor can create a skeleton document, interactively select a sub-section of the skeleton document, and request another user from within the skeleton document interface to modify the selected sub-section. The systems and methods described herein may automate the process of referencing the selected sub-section of the skeleton document and of sending a notification message comprising the selected sub-section to the other user. In one aspect, the other user can modify and update the selected sub-section of the electronic document from within the interactive notification message. Therefore, the disclosure may reduce the communication effort spent in referencing different sub-sections of the electronic document and informing the other users to edit the respective sub-sections. The disclosure may automatically clarify the entry point of a new author joining a collaborative editing session, and may offer a shortcut for how new content may be injected.

Systems and methods disclosed herein provide for collaboration on a portion of an electronic document. One aspect relates to systems and methods for interactively collaborating on a portion of an electronic document. A selection of a portion of an electronic document is received from a first user. A request is received from the first user that a second user edit the selected portion of the document. The second user's access level is determined. In response to the request by the first user, a notification message including the selected portion of the document is transmitted to the second user. A modification of the selected portion of the electronic document is received from the second user via the notification message. The selected portion of the electronic document is updated with the modification.

### BRIEF DESCRIPTION OF THE DRAWINGS

The above and other features of the present disclosure, including its nature and its various advantages, will be more apparent upon consideration of the following detailed description, taken in conjunction with the accompanying drawings in which:

FIG. 1 is a block diagram of a computerized system for editing a sub-section of a collaborative electronic document via a notification message, according to an illustrative embodiment;

FIG. 2 is an example data structure stored on an electronic database that includes a document access control list, according to an illustrative embodiment;

FIG. 3 is an example data structure stored on an electronic database that includes a list of selected sub-sections and their corresponding locations within the document, according to an illustrative embodiment;

FIG. 4 is a block diagram of a computing device, such as any of the components of the system of FIG. 1, for performing any of the processes described herein, according to an illustrative embodiment;

FIG. 5 is a flowchart of a method used by the computerized system to manage editing collaboratively created content of a sub-section of an electronic document through interactive notification messages, according to an illustrative embodiment;

FIG. 6 is a flowchart of a method used by the computerized system to manage the access level of a contributing user, according to an illustrative embodiment;

FIG. 7 is a flowchart of a method used by the computerized system to manage updates to an electronic document, according to an illustrative embodiment;

FIG. 8 is a diagram of an exemplary display of a web browser interface that may be used to interact with a text document, according to an illustrative embodiment;

FIG. 9 is a diagram of an exemplary display of a web browser interface that may be used to make a request to modify text document, according to an illustrative embodiment;

FIG. 10 is a diagram of an exemplary display of an interactive dialog box interface that may be used to request another user to modify a selection of a text document, according to an illustrative embodiment;

FIG. 11 is a diagram of an exemplary display of web browser interface that may be used to display a message to confirm that a request for modification has been sent to another user, according to an illustrative embodiment;

FIG. 12 is a diagram of an exemplary display of a browser-based email client interface that may be used for accessing a notification message, according to an illustrative embodiment;

FIG. 13 is a diagram of an exemplary display of a browser-based email client interface that may be used to view and modify a selected sub-section of a text document from within a notification message, according to an illustrative embodiment;

FIG. 14 is a diagram of an exemplary display of a web browser interface that may be used to interact with a text document, according to an illustrative embodiment;

FIG. 15 is a diagram of an exemplary display of a web browser interface that may be used to interact with a spreadsheet document, according to an illustrative embodiment;

FIG. 16 is a diagram of an exemplary display of a web browser interface that may be used to select a cell of a spreadsheet document and request for modification of the cell, according to an illustrative embodiment;

FIG. 17 is a diagram of an exemplary display of a browser-based email client that may be used for accessing a notification message, according to an illustrative embodiment;

FIG. 18 is a diagram of an exemplary display of a browser-based email client interface that may be used to view and modify a selected cell of a spreadsheet document from within a notification message, according to an illustrative embodiment;

FIG. 19 is a diagram of an exemplary display of a browser-based email client interface that may be used to view and modify a selected cell of a spreadsheet document from within a notification message, according to an illustrative embodiment; and

FIG. 20 is a diagram of an exemplary display of a web browser interface that may be used to interact with a spreadsheet document, according to an illustrative embodiment.

### DETAILED DESCRIPTION

To provide an overall understanding of the disclosure, certain illustrative embodiments will now be described, including a system for collaboratively editing a sub-section of an electronic document via a notification message. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

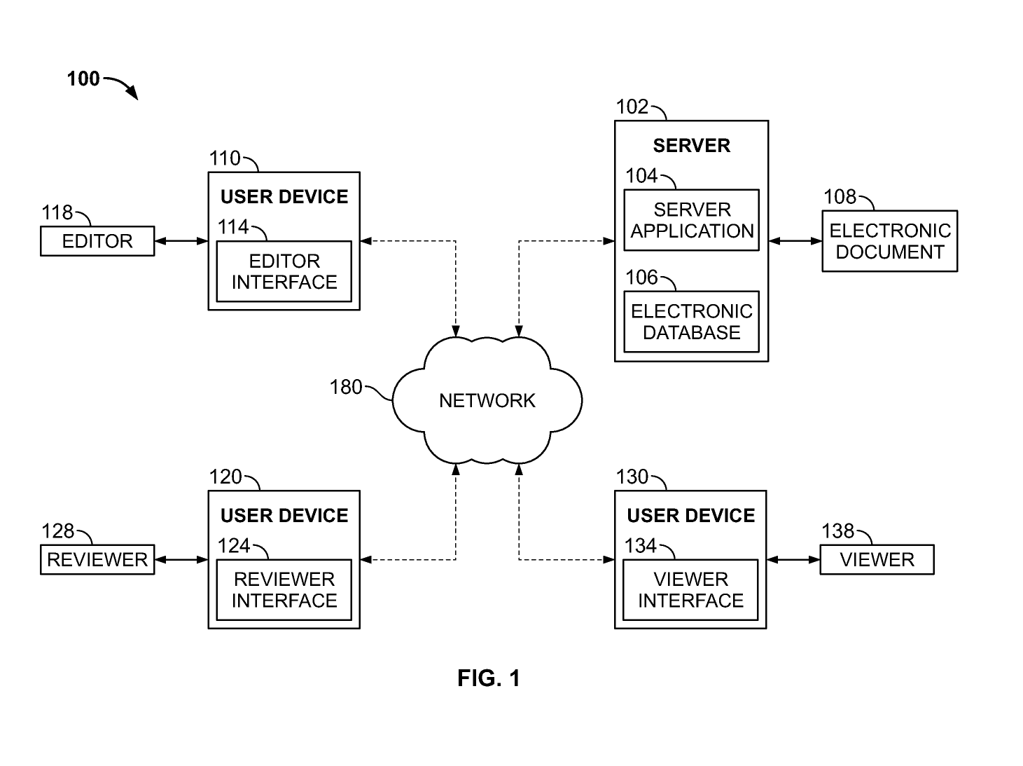

FIG. 1 is a diagram of a system that may be used to implement systems and methods disclosed herein. FIG. 1 is a block diagram of a computerized system 100 for editing a sub-section of a collaborative electronic document via a notification message, according to an illustrative embodiment. System 100 includes a server 102 and user devices 110, 120, and 130 connected over a network 180. The server 102 includes a server application 104 that manages updates to a sub-section of an electronic document 108.

A server application 104 is configured to transmit and receive data over the network 180 in communication with user devices 110, 120, and 130. The server application 104 receives a request to collaborate on a sub-section of the electronic document 108 from an editor 118 of the electronic document 108. The server application 104 stores one or more data structures relevant to updating a sub-section of the electronic document 108 to an electronic database 106. The server application further transmits data to user devices 110, 120, and 130 to coordinate collaboration on a sub-section of the electronic document 108.

The server application 104 may include a processor and a memory unit. The memory unit stores computer executable instructions, which are executed by the processor. The computer executable instructions include instructions for receiving data over the network 180 from user devices 110, 120, and 130, storing data in the electronic database 106, and transmitting a notification message over the network 180 to user devices 110, 120, and 130. As depicted in FIG. 1, the electronic document 108 is stored on a separate device from the server 102, but the electronic document 108 may also be stored in the server's electronic database 106 or even in the memory unit included within the server application 104. In addition, any data described herein as being stored on the electronic database 106 may instead or additionally be stored on the memory unit of the server application 104 or on a separate memory unit external to the server 102.

Users 118, 128, and 138 at user devices 110, 120, and 130, respectively, may interact with the electronic document 108. Each user at a user device may have a user type, defining a level of access to and editing capabilities of the electronic document.

Each user device 110, 120, and 130 may include a device such as a personal computer, a laptop computer, a tablet, a smart phone, a personal digital assistant, or any other suitable type of computer or communication device. Users at the user devices access and receive information from the server 102 over the network 180. The user devices 110, 120, and 130 may include typical components, for example, an input device, an output device, and a communication interface. A user may authenticate with the server 102 by inputting a user name and password (or providing other identification information) via a user interface, such that the same user device may be used by different users at different times.

Users interact with the server 102 such that the users, in conjunction with the server 102, compose an online electronic document by collaboratively modifying a sub-section of the electronic document 108 via a notification message. Although illustrated as a single device in FIG. 1, the server 102 may be implemented as, for example, a single computing device or as multiple distributed computing devices. The interaction of users with the server 102 is through user interfaces 114, 124, and 134, which may include web browsers, email clients, and/or other suitable interfaces. For example, the electronic document 108 may be viewed with an application that displays the electronic document 108 within a web browser. In this arrangement, users may not need to install software locally to their user devices to view and make changes to the electronic document 108. When browsers or user interfaces are discussed herein, these terms are intended to refer to any program that allows a user to browse documents, regardless of whether the browser program is a standalone program or an embedded program, such as a browser program included as part of an operating system. The logic described herein can be implemented in hardware, software, firmware, or a combination thereof.

In an example implementation, the electronic document 108 is a text document. One of skill in the art will understand that the features and concepts described herein may be applied in any type of collaborative documents including, for example, spreadsheet documents, presentation documents, drawing documents, forms, scripts, and other similar collaborative documents. Accordingly, a sub-section of an electronic document may include any suitable subset of the elements making up an electronic document. In one example implementation of a text document, a sub-section may refer to one or more characters. A sub-section may also include a spreadsheet cell, a table row, a form input, a slide, and/or any suitable object. In the context of a sub-section, an object may be an electronic representation of any editable document content.

One type of document user is a reviewer 128 using user device 120, who has a corresponding access level to the electronic document 108. Typically a reviewer may view and make comments on the electronic document 108. To view or make a comment, the reviewer may view the electronic document 108 and make a change to the electronic document 108. Data indicative of the change may be sent over the network 180 to the server 102, where the server application 104 may receive the data and update the electronic document 108 with a comment on a side bar of the electronic document 108. In some implementations, the reviewer 128 may not be able to view the electronic document 108 and may provide suggested edits and/or comments on the document via a notification message.

Another type of document user is an editor 118 using user device 110, who may have a greater level of authority over the electronic document 108 than the reviewer 120. Greater level of authority herein means a higher access level and/or lesser restrictions on how a user can interact with an electronic document. In some implementations, the editor 118 may view, edit, and/or comment on a sub-section of the electronic document 108. The editor may select a sub-section of the electronic document 108 through a browser interface and send a request, in conjunction with the server 102 over network 180, to another user to modify the selected sub-section of the electronic document 108. The editor may also modify the electronic document 108 to incorporate content of the comments received from a reviewer in response to modifications requested for selected sub-sections of the electronic document 108.

Another type of document user is a viewer 138 at device 130, who may have a lower level of authority over the electronic document 108 than the reviewer 128. Lower authority level herein means a lower level of access and/or more restrictions on how a user can interact with an electronic document. In some implementations, the viewer 138 may only view the electronic document 108. In contrast to the reviewer 128 and the editor 118, the viewer 138 generally may not modify or comment on the electronic document 108.

The updates to the electronic document 108 may be performed in real time. This means when a reviewer 128 from user device 120 modifies a selected sub-section of the electronic document 108 from a notification message or from within a web browser, the editor 118 viewing the electronic document 108 on user device 110 almost immediately sees the modifications made to the electronic document 108.

The reviewer 128 at user device 120 and the editor 118 at user device 110 may view who else is currently viewing the electronic document 108. When more than one user views the electronic document 108 at a time, the users may communicate with each other over an instant messaging application.

Only one user of each user type is shown in FIG. 1 to avoid complicating the drawing; however the system 100 can also support multiple users with the same user type. When there are multiple reviewers, a reviewer 128 may view edits and comments made by other reviewers 128. In this way, by allowing for efficient collaboration across a set of users contributing content to different sub-sections of the electronic document 108, the system 100 may offer significant advantages over a system in which reviewers independently provide modifications to the different sub-sections of an electronic document. Thus, when an editor 118 views the electronic document 108, the editor 118 may view a live stream of collaborative updates made by multiple reviewers 128 at the same time, significantly reducing the amount of time and/or overhead to develop the electronic document 108.

In the case of the interfaces 114, 124, and 134, each user may be assigned a unique color, such that the changes in the electronic document 108 are color-coded by the user who made the changes. In addition, changes made by editors 118 may be marked differently on the electronic document 108 from changes made by reviewers.

In some implementations, any member of the public may have a user type of viewer 138 by default. In other embodiments, only users approved by a reviewer 128 and/or an editor 118 have viewer status.

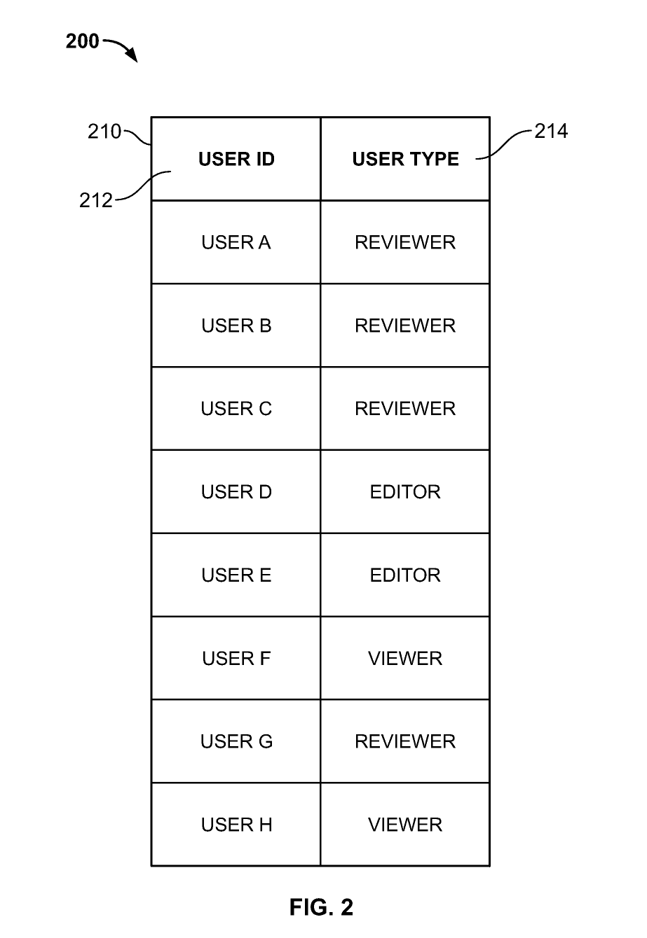

FIG. 2 shows an example data structure 210 stored on an electronic database similar to the electronic database 106 of FIG. 1. The data structure 210 may include an electronic document access control list, according to an illustrative embodiment. The document access control list includes a list of users who have access to an electronic document similar to the electronic document 108 of FIG. 1 and their corresponding user types. The list of users may comprise an identifier for each user. For example, the list of users may comprise a user ID, a user name, a user e-mail, and/or any suitable identifier thereof. In this case, multiple users have the same user type. In particular, there are four reviewers (users A-C and G), two editors (users D and E), and two viewers (users F and H), one or more of whom may, respectively, interact with the electronic document similar to the electronic document 108. In addition to the list of users and their corresponding user types, the document access control list may include other fields such as read permissions, write permissions, edit permissions, comment permissions, or any suitable combination thereof.

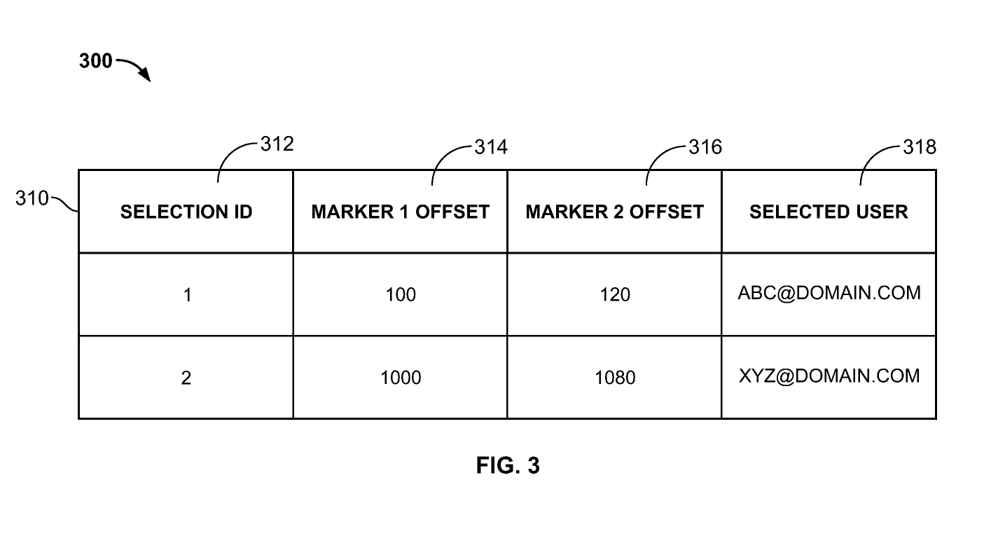

FIG. 3 is an example data structure 310 stored on an electronic database similar to the electronic database 106 of FIG. 1. The data structure 310 may include a list of markers for identifying the location of a sub-section of an electronic document similar to the electronic document 108 of FIG. 1. The selection ID field 312 may include a unique identifier for a sub-section of the electronic document 108. The marker 1 offset field 314 may store the location of the starting point of the corresponding sub-section. The marker 2 offset field 316 may store the ending location of the corresponding sub-section. The selected user field 318 may store an identifier of a user selected by an editor, similar to editor 118 of FIG. 1, to modify the corresponding sub-section identified by selection ID. The identifier may be a user ID, a user name, a user e-mail, and/or any suitable identifier thereof. The selected user field 318 may also contain a list of multiple identifiers of corresponding users selected to edit the sub-section identified by the corresponding selection ID. In some implementations, the data structure may include an entry for the length of the corresponding sub-section in combination with marker 1 and/or marker 2 offsets. The offsets can be stored as a number, an alphanumeric character, and/or other suitable representations for a location within an electronic document. The data structure may further include fields such as time of selection, time of editing, and/or other fields related to the corresponding sub-section.

When an electronic document, similar to the electronic document 108 of FIG. 1, is modified, a server application similar to the server application 104 of FIG. 1 updates the offsets stored in the data structure 310. For example, if content is added before the corresponding sub-section, the length of the added content may be added to the marker 1 and marker 2 offsets to adjust for the change. Likewise, the offsets may be adjusted for deletions from the electronic document.

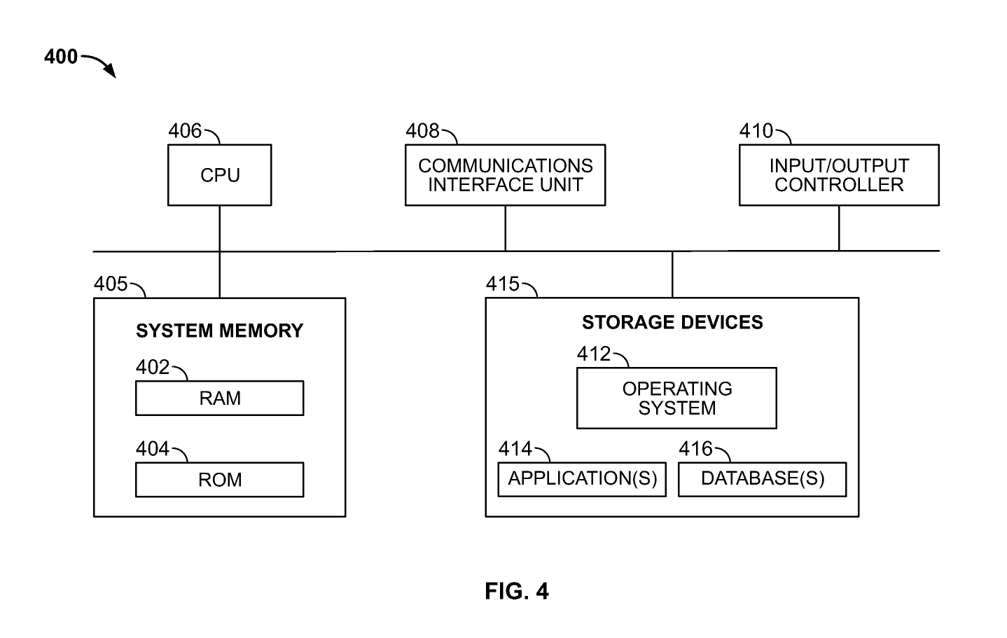

FIG. 4 is a block diagram of a computing device 400, such as any of the components of the system of FIG. 1, for performing any of the processes described herein. Each of the components of these systems may be implemented on one or more computing devices 400. In some aspects, a plurality of the components of these systems may be included within one computing device 400. In some implementations, a component and a storage device may be implemented across several computing devices 400.

The computing device 400 comprises at least one communications interface unit 408, an input/output controller 410, system memory 405, and one or more data storage devices 415. The system memory includes at least one random access memory (RAM 402) and at least one read-only memory (ROM 404). All of these elements are in communication with a central processing unit (CPU 406) to facilitate the operation of the computing device 400. The computing device 400 may be configured in many different ways. For example, the computing device 400 may be a conventional standalone computer or alternatively, the functions of computing device 400 may be distributed across multiple computer systems and architectures. In FIG. 4, the computing device 400 can be linked, via network or local network, to other servers or systems.

The computing device 400 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 408 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 406 comprises a processor, such as one or more conventional microprocessors and one or more supplementary co-processors such as math co-processors for offloading workload from the CPU 406. The CPU 406 is in communication with the communications interface unit 408 and the input/output controller 410, through which the CPU 406 communicates with other devices such as other servers, user terminals, or devices. The communications interface unit 408 and the input/output controller 410 may include multiple communication channels for simultaneous communication with, for example, other processors, servers or client terminals.

The CPU 406 is also in communication with the data storage device. The data storage device may comprise an appropriate combination of magnetic, optical or semiconductor memory, and may include, for example, RAM 402, ROM 404, and flash drive, an optical disc such as a compact disc or a hard disk or drive. The CPU 406 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 406 may be connected to the data storage device via the communications interface unit 408. The CPU 406 may be configured to perform one or more particular processing functions.

The data storage device may store, for example, an operating system 412 for the computing device 400; (ii) one or more applications 414 (for example, computer program code or a computer program product) adapted to direct the CPU 406 in accordance with the systems and methods described here, and particularly in accordance with the processes described in detail with regard to the CPU 406; or (iii) database(s) 416 adapted to store information that may be utilized to store information required by the program.

The operating system 412 and applications 414 may be stored, for example, in a compressed, an un-compiled and an encrypted format, and may include computer program code. The instructions of the program may be read into a main memory of the processor from a computer-readable medium other than the data storage device, such as from the ROM 404 or from the RAM 402. While execution of sequences of instructions in the program causes the CPU 406 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to editing a sub-section of an electronic document via a notification message as described herein. The program also may include program elements such as an operating system 412, a database management system and “device drivers” that allow the processor to interface with computer peripheral devices (for example, a video display, a keyboard, a computer mouse, etc.) via the input/output controller 410.

The term “computer-readable medium” as used herein refers to any non-transitory medium that provides or participates in providing instructions to the processor of the computing device 400 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying, one or more sequences of one or more instructions, to the CPU 406 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 400 (for example, a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

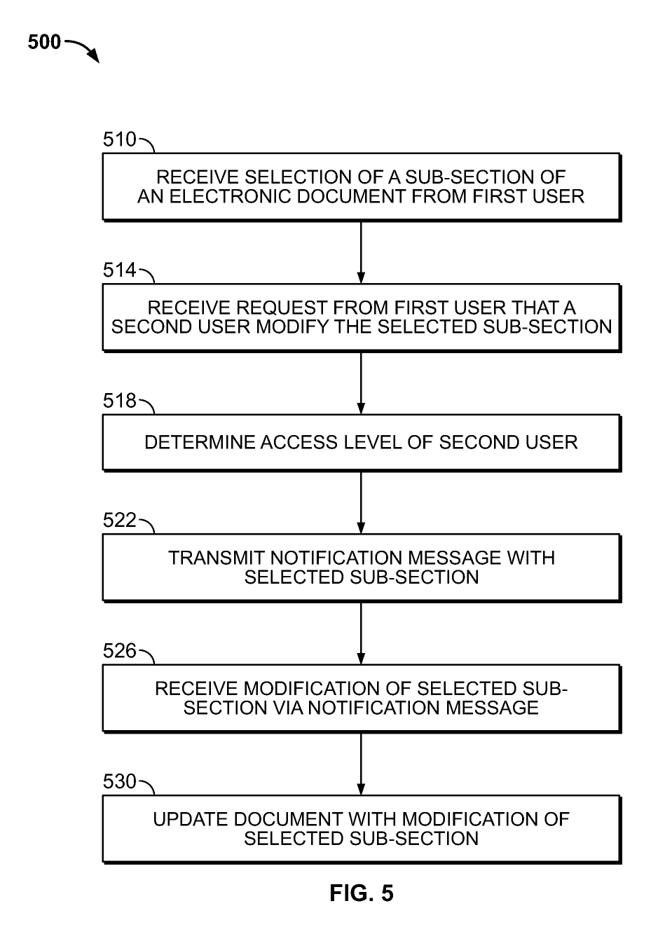

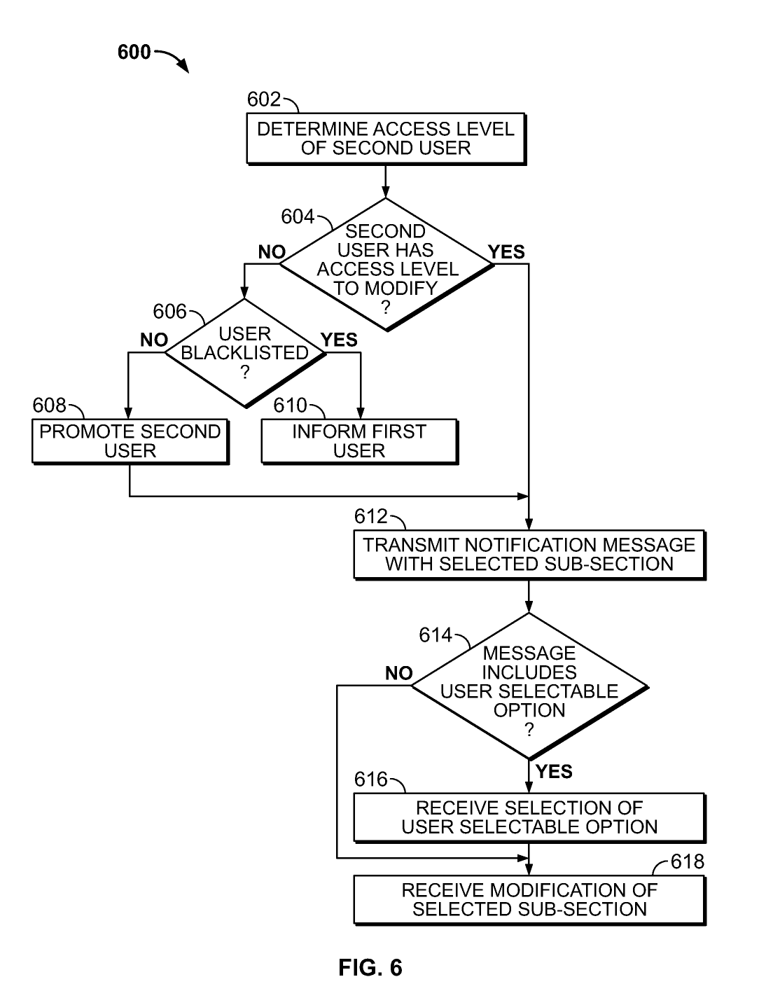

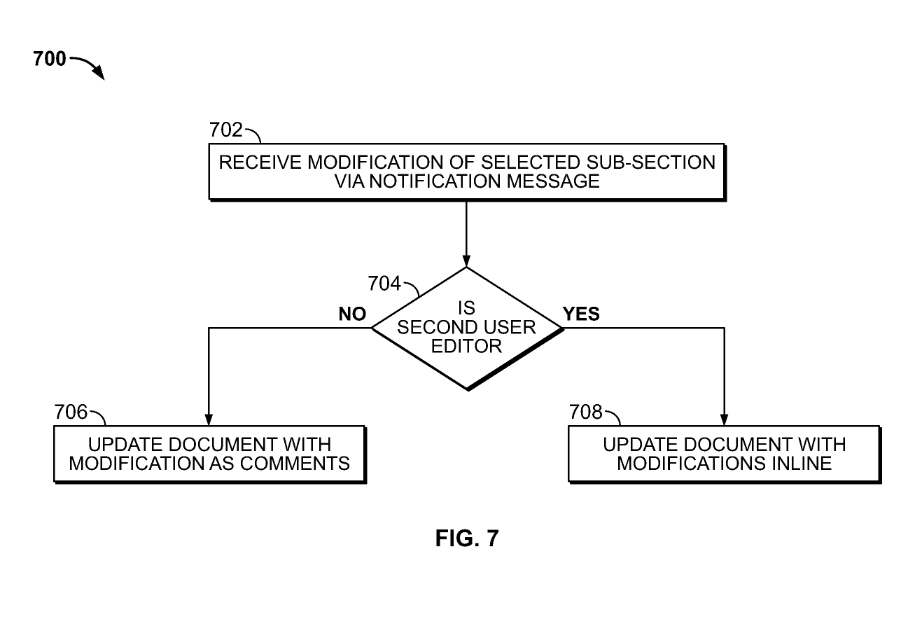

FIGS. 5-7 show methods implemented by a server application, similar to the server application 104 of FIG. 1, to manage updates to a sub-section of an electronic document, similar to the electronic document 108 of FIG. 1, via a notification message. FIG. 5 shows a method 500 used by the server application to transmit, receive, and store data for managing updates to the sub-section of the electronic document. FIG. 6 shows a method 600 used by the server application to determine that a user requested to modify the electronic document has an appropriate access level to make the requested modification to the electronic document. FIG. 7 shows a method 700 used by the server application to store updates to the electronic document.

Referring back to FIG. 5, method 500 of FIG. 5 may start at step 510. At step 510, the server application may receive from a first user a selection of a sub-section of an electronic document, similar to the electronic document 108 of FIG. 1. The first user may be similar to the editor 118 or reviewer 128 of FIG. 1. The first user may make the selection using a corresponding interface 114 or 124 of FIG. 1. In some implementations, the interface can be a web browser, and the first user may be prompted for credentials before obtaining access to the electronic document. The electronic document can be a text document, spreadsheet document, presentation document, drawing document, form, script, and/or other suitable collaborative documents.

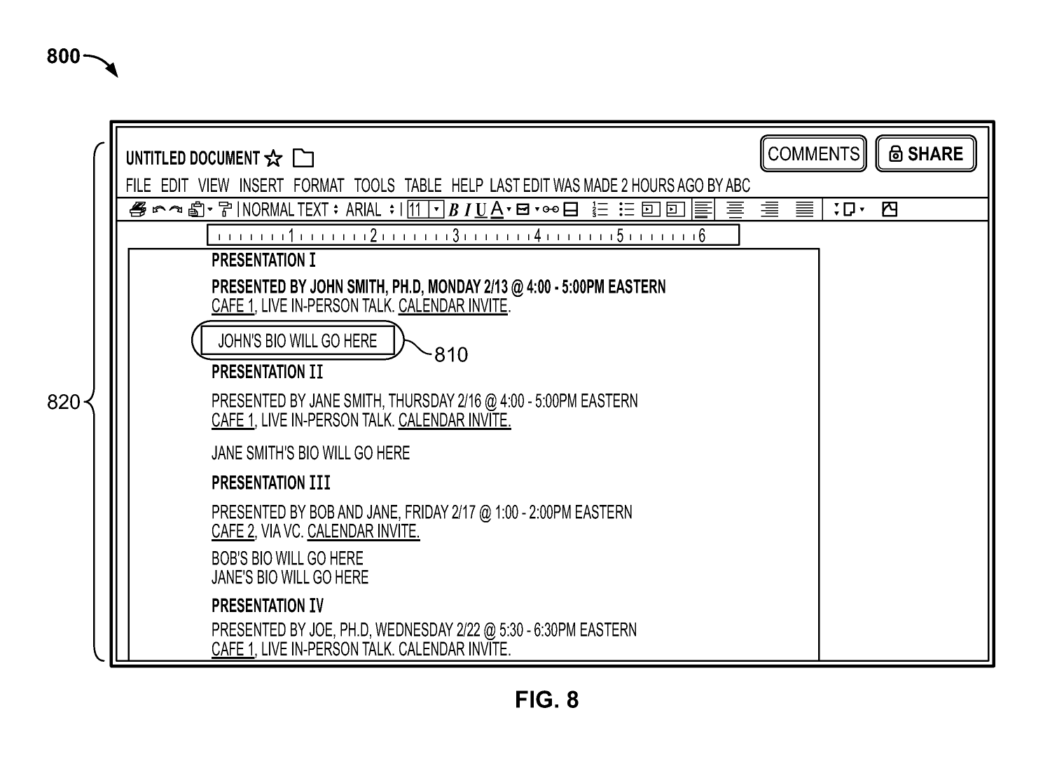

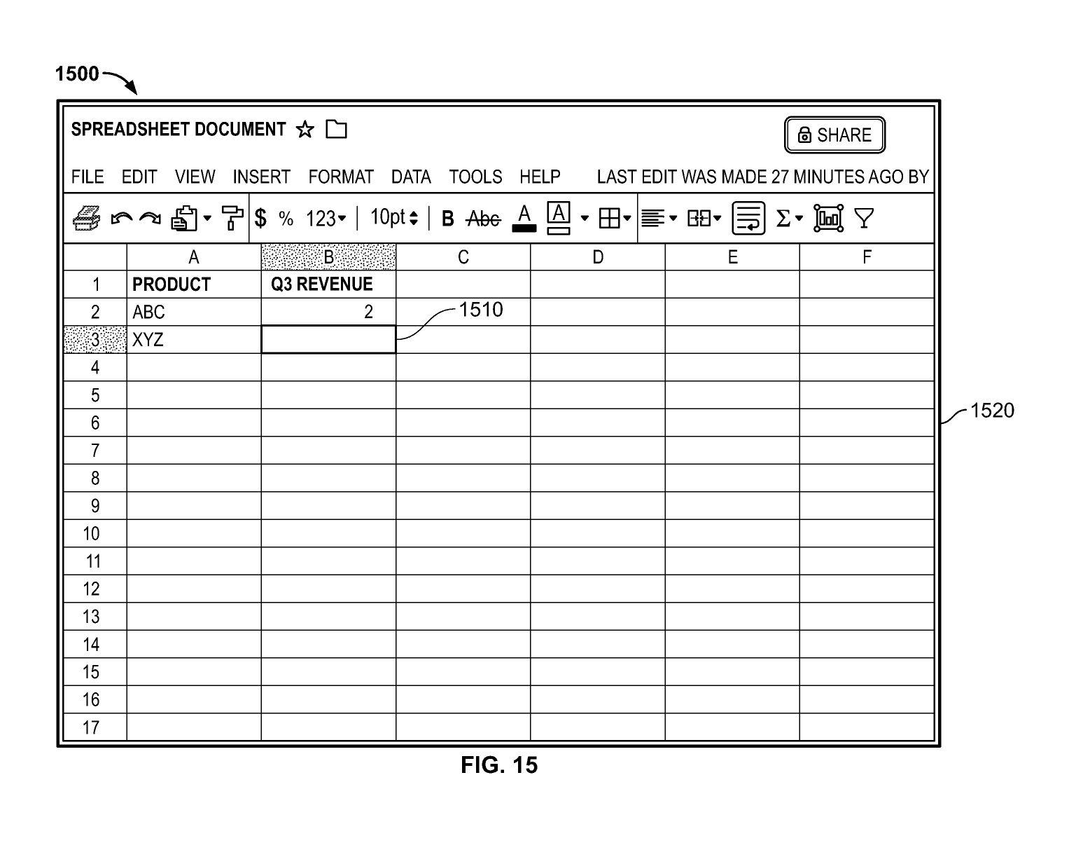

FIGS. 8-14 show exemplary user interfaces that may be used to access and interact with the electronic document in the exemplary case where the electronic document is a text document. FIGS. 15-20 show exemplary user interfaces that may be used to access and interact with the electronic document in the exemplary case where the electronic document is a spreadsheet document. These user interfaces are exemplary and other suitable interfaces may be used with the same or other types of electronic documents without departing from the scope of this disclosure.

FIG. 8 shows an exemplary web browser interface 800 that may be used by the first user of FIG. 5 to select a sub-section of a text document 820. The first user can make a selection 810 of a sub-section by highlighting one or more characters of the text document. Alternatively, the first user may specify a location of a selection of a sub-section, such that the second user may modify the document at the specified location. The selection 810 of a text document may be a character, a text-box, a table object, a drawing, a chart, and/or other suitable elements included in a text document. The selection 810 of the sub-section may be received by the server application at step 510 of FIG. 5.

FIG. 15 shows an exemplary web browser interface 1500 that may be used by the first user of FIG. 5 to select a sub-section of a spreadsheet document 1520. The first user can make a selection 1510 of a sub-section by highlighting one or more cells of the spreadsheet document 1520. Alternatively, the first user may specify a location of a selection of a sub-section, such that the second user may modify the document at the specified location. The selection 1510 of the sub-section may be received by the server application at step 510 of FIG. 5.

In some implementations the highlighting of the selected sub-section of the spreadsheet document and/or the text document can be done by using an input pointing device such as a mouse, touchpad, trackball, joystick, stylus, and/or other suitable devices.

At step 514 of FIG. 5, the server application may receive a request that a second user modify the selection received at step 510, for example, the selection 810 of one or more characters of a text document similar to the text document 820 of FIG. 8 or the selection 1510 of one or more cells of a spreadsheet document similar to the spreadsheet document 1520 of FIG. 15. The first user may use a corresponding interface such as interfaces 114 or 124 of FIG. 1 to request that the selection 810 of a sub-section of the text document or selection 1510 of a sub-section of the spreadsheet document be modified by the second user. A modification of a text document herein includes any suitable operation to the text document, such as adding, inserting, replacing, and/or deleting one or more characters from a selection of text, e.g., from selection 810 of FIG. 8. A modification of a spreadsheet document herein includes any suitable operation to a spreadsheet document, such as adding, inserting, replacing, and/or deleting content of one or more selected cells, for example, from selection 1510 of FIG. 15. The content of a spreadsheet cell may include without limitation a character, an object, a formula, and/or any other suitable element.

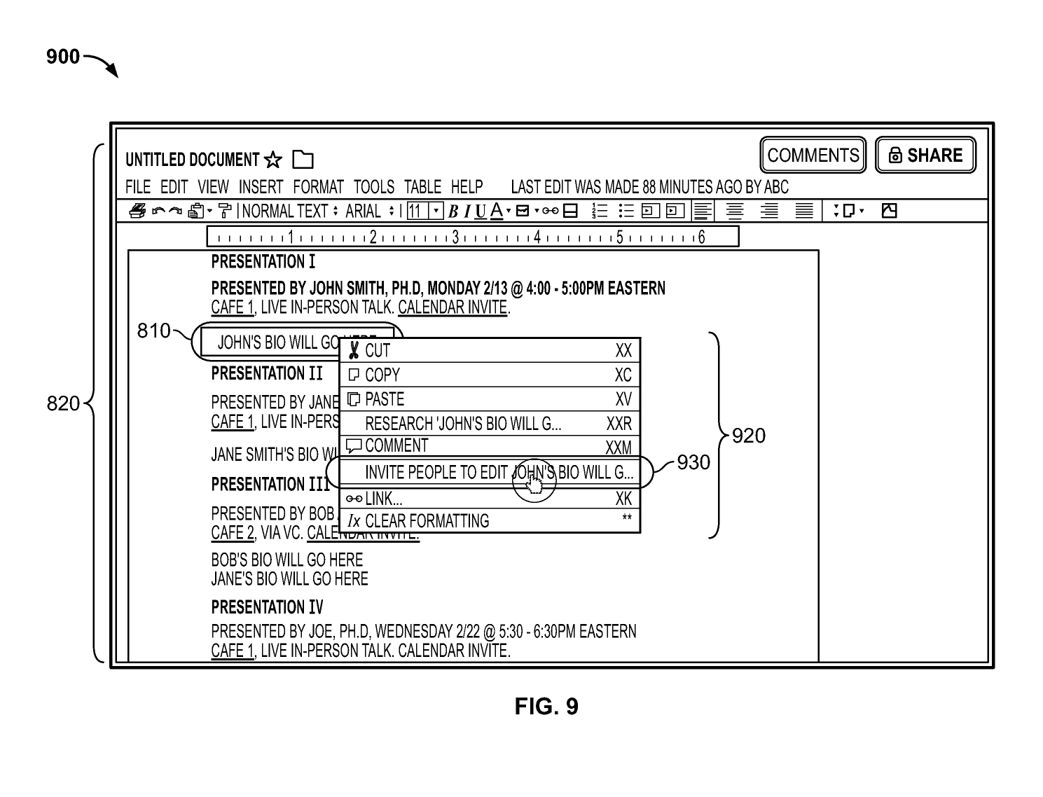

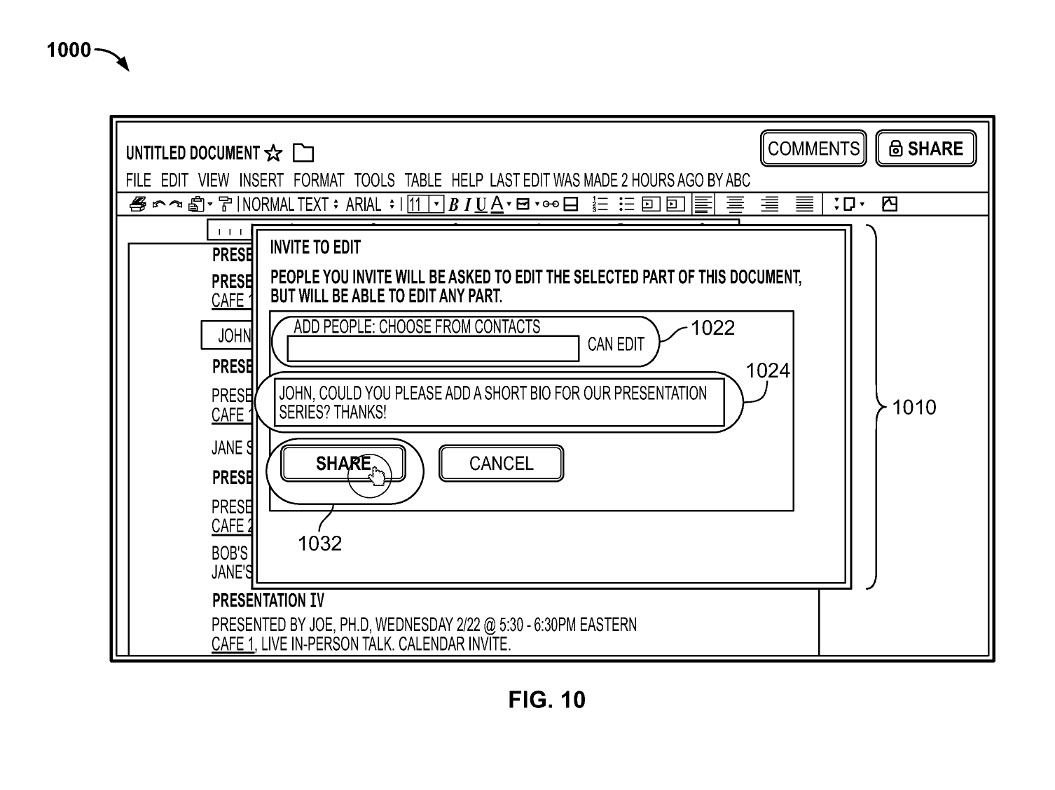

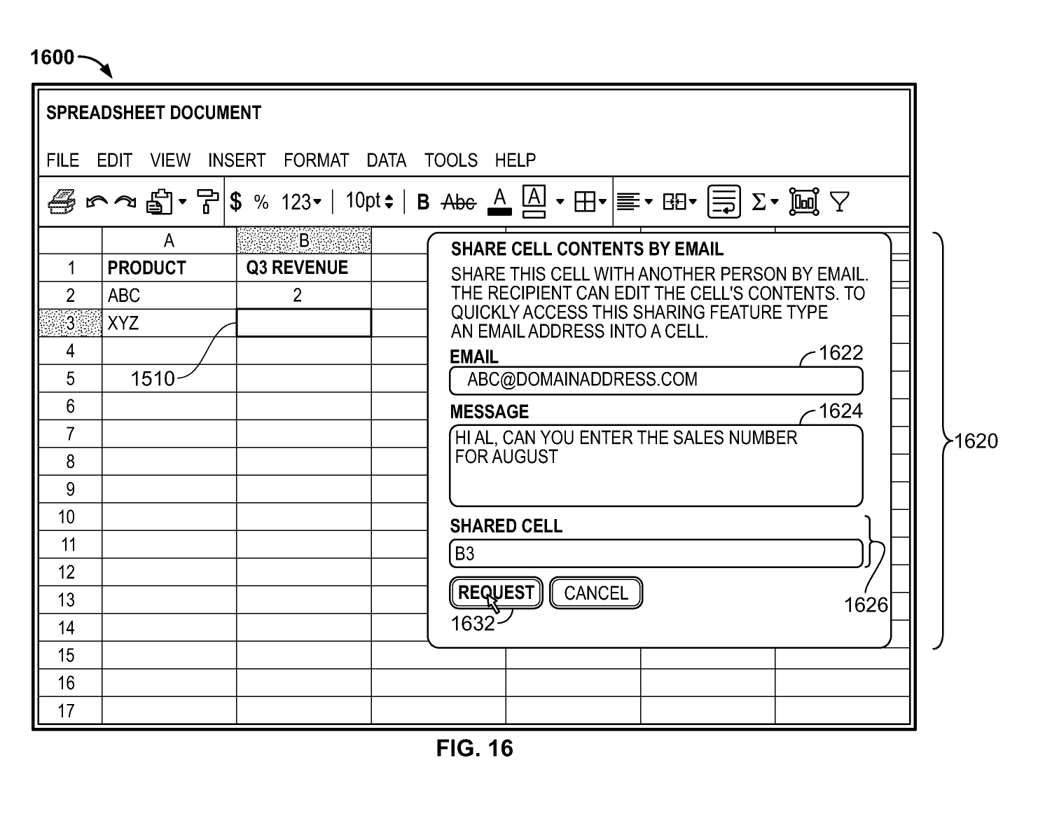

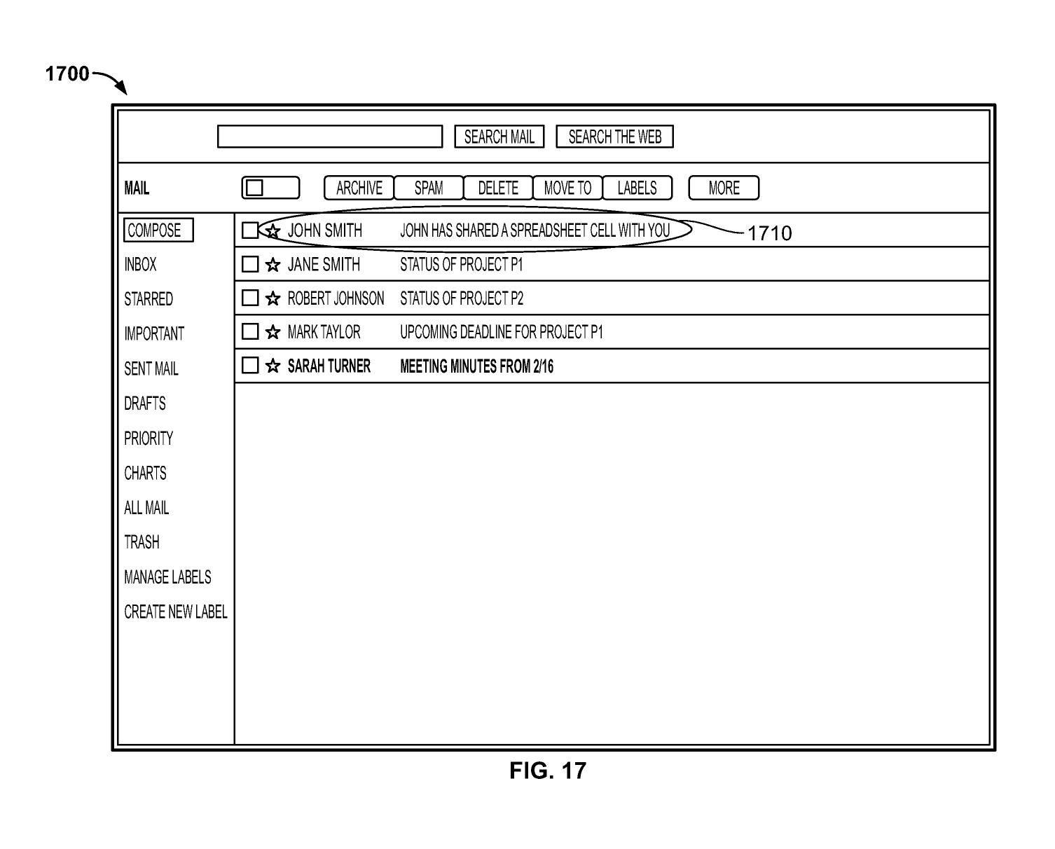

FIGS. 9 and 10 show exemplary interfaces that may be used by the first user to make a contribution request when the electronic document is a text document. FIGS. 16 and 17 show exemplary user interfaces that may be used by the first user to make a contribution request when the electronic document is a spreadsheet document.

FIG. 9 shows an exemplary web browser interface 900 to make a request to modify a text document, for example, to modify the text document 820 after the document is accessed in FIG. 8. In some implementations of the browser interface, the first user may open a menu 920 for the selection 810 of a sub-section, for example, after the selection is highlighted in FIG. 8. In some implementations of the interface, the menu 920 for the selection 810 of a sub-section may be opened by right clicking on the selection 810. The first user may further select an option 930 to invite a second user to edit the selection 810 of a sub-section. In response to the selection of option 930 by the first user, the interface 900 may display an interactive dialog box such as the one shown in FIG. 10 below.

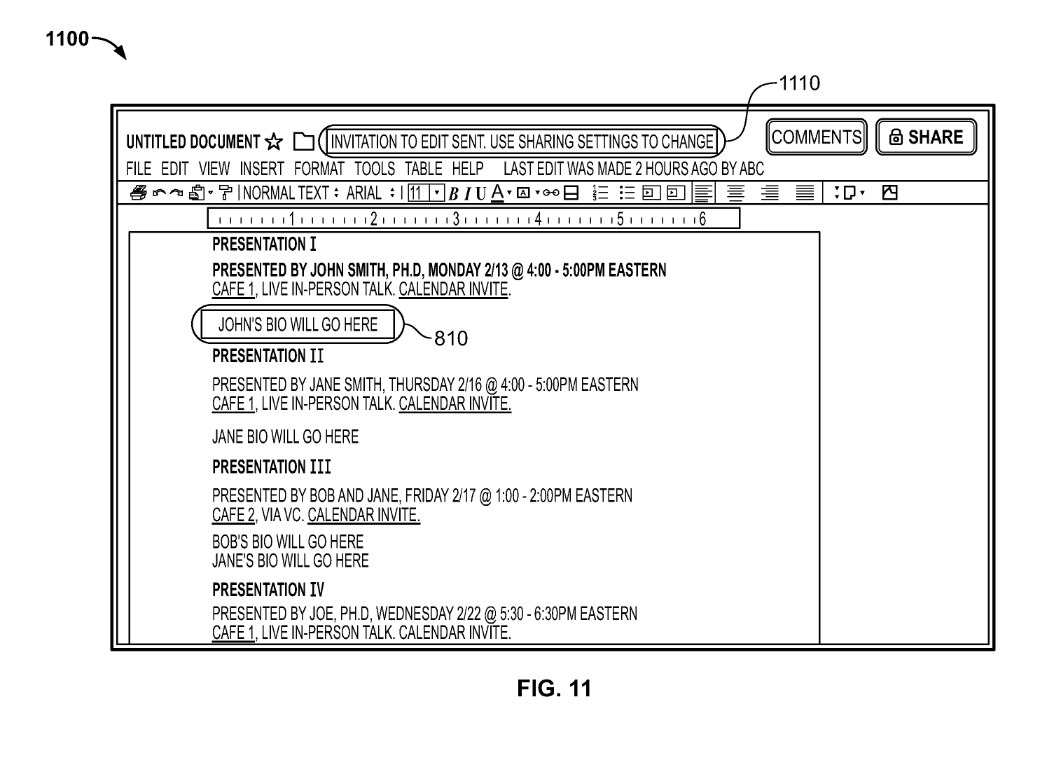

FIG. 10 shows an exemplary web browser interface 1000 including an interactive dialog box 1010 that may be used by the first user, from step 510 of FIG. 5, to request that a second user modify a selection similar to the selection of a sub-section received at step 510 of FIG. 5. The interactive dialog box 1010 may include one or more input fields. FIG. 10 shows two exemplary input fields 1022 and 1024. The first user may enter an identification of the second user in input field 1022. In some implementations of the interface, the first user may enter the email address of second user in the field 1022 to identify the second user. The input field 1024 may be used by the first user to input a message for the second user. For example, the first user may add a description of the modification requested from the second user in input field 1024, such as asking for biographical information as shown in the illustrated input field 1024, and/or any desired message to the second user. After filling in the input field 1022, the first user can select a user-selectable option 1032 to confirm and/or submit the request. In response to the selection of the user-selectable option 1032, data indicative of the request are transmitted to the second user via a server application similar to the server application 104 shown in FIG. 1. In some implementations, the web browser 1000 may display a message, confirming the submission of the request by the first user, such as the one shown in FIG. 11 below.

FIG. 11 shows an exemplary web browser interface 1100 including a message 1110. The web browser interface may be similar to the web browser interface 800 of FIG. 8 and may be used to access a text document similar to the text document 820 of FIG. 8. The message 1110 may be displayed to confirm receipt of a request by the first user of FIG. 5 that a second user modify a selection of a sub-section of a text document. The message 1110 may be displayed in response to the execution step 514 of FIG. 5.

FIG. 16 shows an exemplary web browser interface 1600 that may be displayed to the first user for making a request to the second user to edit the selected sub-section 1510 of the spreadsheet document 1520, for example, after the document 1520 is accessed in FIG. 15. In some implementations of the interface, the first user may open a menu, similar to the menu 920 shown in FIG. 9, for the selection 1510 of a sub-section. The menu for the selection 1510 of a sub-section may be opened by right clicking on the selection 1510. The first user can select an option, similar to the option 930 shown in FIG. 9, to invite a second user to edit the selection 1510 of a sub-section. In response to the selection of the option, the interface may display an interactive dialog box 1620. The interactive dialog box may include one or more input fields. FIG. 16 shows three exemplary input fields 1622, 1624, and 1626. The first user may enter an identification of the second user in input field 1622. In some implementations of the interface, the first user may enter the email address of the second user in the input field 1622 to identify the second user. The input field 1624 may be used to enter a message for the user identified in the input field 1622. This field may be similar to input field 1024 of FIG. 10, and may be used by the first user to input a message for the second user. For example, the first user may add a description of the modification requested from the second user in input field 1624, such as asking for a missing value as shown in illustrative input field 1624, or any desired message to the second user. The input field 1626 may be used to enter a cell location number instead of and/or in addition to the selected spreadsheet document cell 1510. In some implementations, the input field 1626 can be automatically populated with the cell location number, for example, based on the selection 1510 of a sub-section. After filling out the input field 1622, the first user can select a user-selectable option 1632 to confirm and/or submit the request to the second. In response to the selection of the user-selectable option 1632, the interface transmits data indicative of the request to the second user via the server application 104.

Returning to FIG. 5, at step 518, the server application determines the access level of the second user selected by the first user to edit a selected sub-section of the electronic document from steps 510 and 514. To determine the access level, the server application may access a document access control list such as data structure 210 of FIG. 2. In the illustrative case where the electronic document is the text document 820 of FIG. 8, the server application may check the identification provided by the first user, using the input field 1022 of FIG. 10, against the user ID field 212 of the access control list of data structure 210 and retrieve the corresponding user type 214. In the illustrative case where the electronic document is the spreadsheet document 1520 of FIG. 15, the server application 104 may check the identification provided by the first user using the input field 1622 of FIG. 16 against the user ID field 212 of the access control list of data structure 210 and retrieve the corresponding user type 214. The server application 104 may determine the access level of the user based on the retrieved user type. If the user ID is not found in the data structure 210, then by default the user may be assumed to not have access to the electronic document 108. In some implementations, the server application may bypass step 518 and proceed with step 522 of the method 500.

At step 522, the server application transmits a notification message, comprising the selected sub-section of the electronic document from step 510, to the second user whose input is requested in step 514. The second user can access the notification message using an electronic message interface. The electronic message interface can be a browser-based email client, a native email client, a chat messenger application, a social network application and/or any other suitable application.

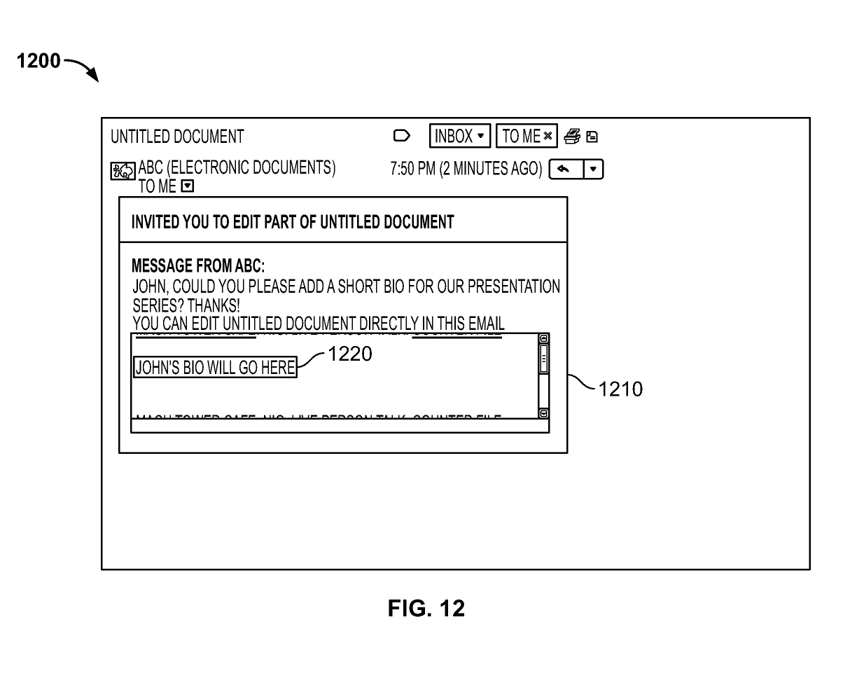

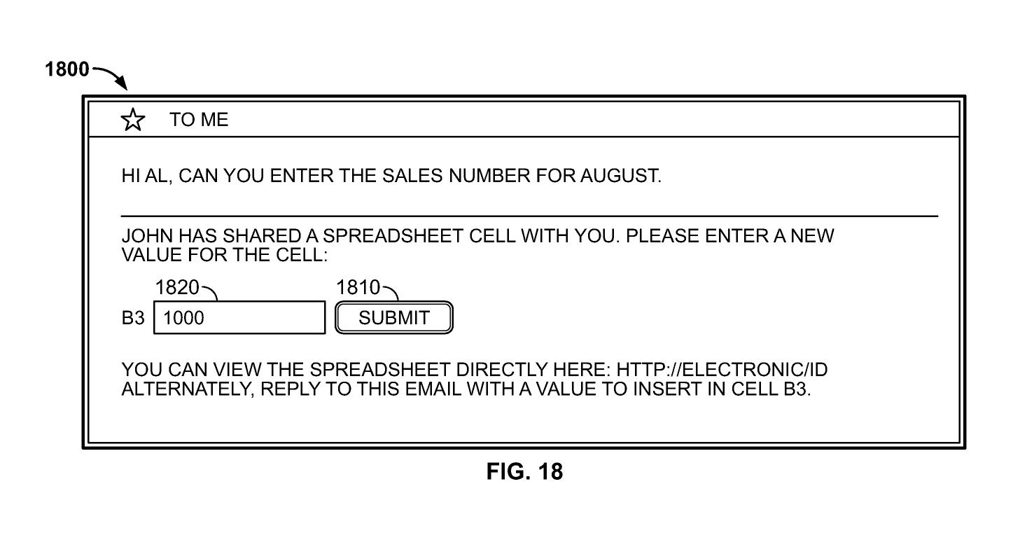

FIG. 12 shows an exemplary browser-based email client interface 1200 for accessing the notification message in the exemplary case where the electronic document is a text document. FIGS. 17 and 18 show exemplary browser-based email client interfaces 1700 and 1800, respectively, for accessing the notification message when the electronic document is a spreadsheet document.

FIG. 12 shows an exemplary interface 1200 of a browser-based e-mail client used by the second user to view a notification message 1210. The notification message 1210 may include a selection 1220 of a sub-section of the text document. The selection 1220 of a sub-section corresponds to the selection 810 of a sub-section of the text document 820 from FIG. 8. In some implementations, the notification message includes a reference to the location of the selection 810 of the sub-section of the text document 820, such as the relative location of the selected subsection within the electronic document. The reference may also include the electronic location of the electronic document, the data from data structure 310 of FIG. 3, and/or other suitable data related to the document. The notification message interface can in turn use the reference to dynamically render the selection 1220 of a sub-section when the second user accesses the notification message.

FIG. 17 shows an exemplary interface 1700 of a browser-based e-mail client used by the second user to view the notification message 1710. An exemplary implementation of the browser-based e-mail client 1700 displays the name of the first user, from step 510 of FIG. 5, and/or a subject indicating that the first user has shared a spreadsheet cell. The subject line of the exemplary browser-based e-mail client 1700 may include a summary of the contents of a corresponding e-mail and/or a description of the contribution request made by the first user.

FIG. 18 shows an exemplary interface 1800 for reviewing the contents of the notification message for the spreadsheet document 1520 of FIG. 15. The notification message includes a selection 1820 showing content of a selected sub-section of the spreadsheet document 1520. In the illustrated example, the selection 1820 corresponds to the value “1000” from the cell selected by the first user in step 510. In some implementations, the notification message will include a reference to the location of the selection 1510 of sub-section of one or more cells. The notification message interface can in turn use the reference to dynamically render the selection 1510 of a sub-section when the notification message is accessed by the second user.

At step 526, the server application receives a modification of the selected sub-section of the electronic document from the second user. A modification of an electronic document herein includes adding, inserting, replacing, and/or deleting content from a selected sub-section of an electronic document. In some implementations, the second user may make the modification directly from the notification message transmitted in step 522. In some implementations, the second user may make the modification by accessing the electronic document using a URL provided in the notification message, which when selected by the second user in a browser-based interface, directs the second user to the electronic document such that the electronic document opens at the selected sub-selection.

In the case where the second user can make the modification directly from the notification message, the electronic document, similar to electronic document 108 of FIG. 1, may be updated in real time. In some implementations, a sub-section of the electronic document may be rendered in the notification message. The notification message may include a reference to the sub-section and/or data representing the location of the electronic document. Some notification message interfaces may be able to use the data to request a server application, similar to the server application 104 of FIG. 1, for the referenced sub-section of the electronic document. In response to the request, the server application may transmit data indicative of the sub-section to the notification message interface. On receiving the data from the server application, the notification message interface may render the sub-section and/or an interface for editing the electronic document from within the notification message. The second user may edit the electronic document directly by modifying the sub-section from the rendered interface. The interface rendered in the notification message may be similar to the interfaces 114, 124, and/or 134 of FIG. 1.

The rendering of the sub-section and/or inclusion of a URL to the sub-section within the notification message reduces the tediousness of a process of a first user manually referring to a sub-section of an electronic document. For example, in the absence of the rendered sub-section and/or URL to the sub-section, a first user may have to look at an electronic document, copy a sub-section into a notification message, and/or refer to a location of the sub-section within the electronic document. A location here, for example may refer to a paragraph number, a line number, byte offset, cell number, and/or the URL of the electronic document within the electronic document. The first user may also need to include editing instructions for the contributing users. Depending on the nature of the content, the first user may need to repeat these steps for each contributing user. The feature described herein reduces the ambiguity of manually referring to a sub-section of the electronic document by directly rendering the sub-section in the notification message and/or including a URL to the sub-section. In some implementations, the server application may store and maintain the relative location of the sub-section within the electronic document. Storing this information allows the notification message interface to render and/or link the same sub-section in the notification message as originally intended by the first user. Therefore, the reference to the selected sub-section does not become obsolete when modifications are made to the electronic document. In the case of multiple collaborative users, the rendered sub-section and/or URL to the sub-section may allow the second user to see the most up to date version of the sub-section and make changes accordingly. This may reduce the ambiguity associated with the collaborative editing process, thereby increasing the efficiency of the process.

The rendering of an interface to modify the electronic document within the notification message and/or modifying the sub-section using the URL included in the notification message reduces the communication overhead involved in sending back a modified sub-section to the first user and/or the tediousness of the process of the first user merging the modification with electronic document. This feature further reduces the extra steps of the second user opening the electronic document, finding the relevant sub-section, and modifying the sub-section. The rendering of the sub-section and/or inclusion of the URL to the sub-section also clarifies the entry point for the second user. This clarification prevents errors in cases when the second user can mistakenly edit another sub-section of the electronic document. It provides an unambiguous entry point for the second user to modify the electronic document and may increase the efficiency of the collaborative editing process.

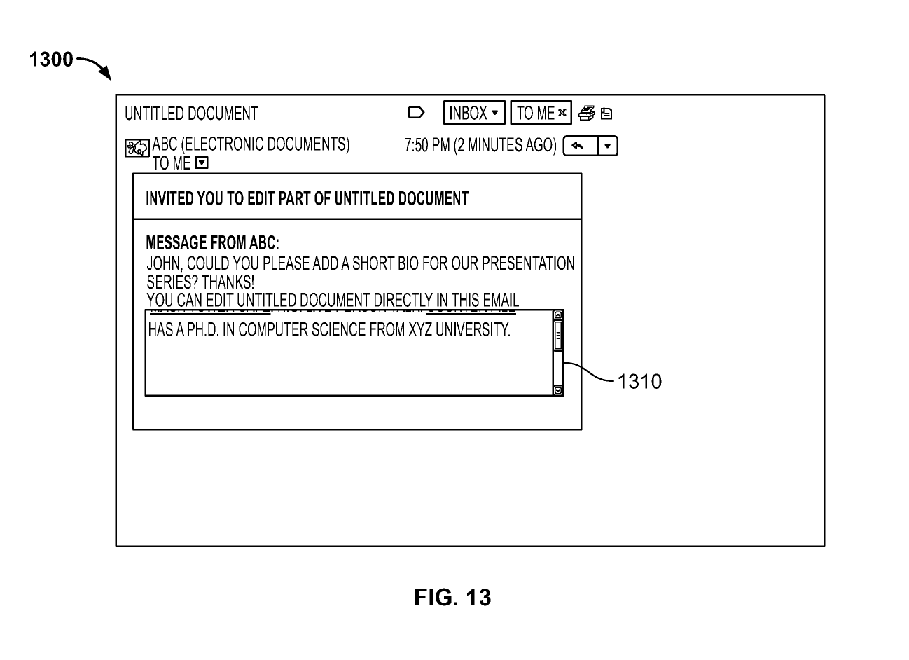

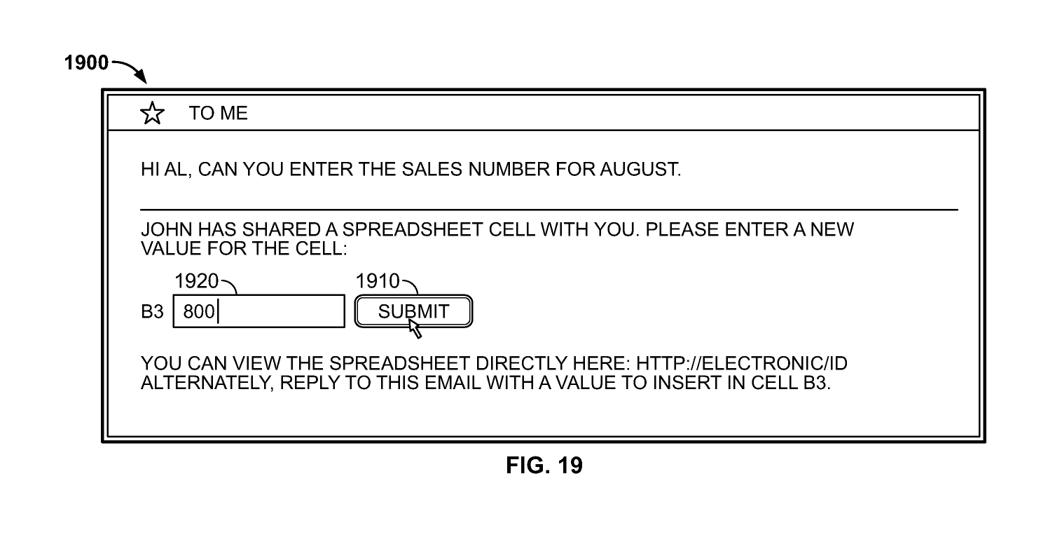

FIGS. 13 and 19 show exemplary e-mail client interfaces used by the second user to modify the notification message, in the exemplary cases of a text document and a spreadsheet document, respectively.

FIG. 13 shows an exemplary interface 1300 of a browser-based email client used by the second user to view and modify a selected sub-section of a text document, similar to the selected sub-section 810 of the text document 820 of FIG. 8 respectively. The second user may use the browser-based email client to make a modification 1310 such as addition of a new paragraph to the selection of a sub-section of the text document. Data indicative of the modification 1310 are transmitted to a server, similar to server 102 of FIG. 1, via a network, such as network 180 of FIG. 1, and may be received by the server application at step 526.

FIG. 19 shows an exemplary interface 1900 of a browser-based e-mail client used by the second user to view and/or modify the cell from selection 1510 of a sub-section of the spreadsheet document 1520. The second user may use a browser-based e-mail client to make a modification 1920 to the selection 1510 of a sub-section of the spreadsheet document 1520. The second user, in the shown example, inputs a value “800” in the cell 1820 included in the notification message shown in FIG. 18. The resulting modification 1920 displays the value entered by the second user. In some implementations, the notification message may include a user-selectable option 1910, which can be used by the second user to confirm and/or submit the modification. Data indicative of the modification 1920 are transmitted to a server similar to server 102 of FIG. 1 via a network similar to network 180 of FIG. 1 and may be received by the server application at step 526.

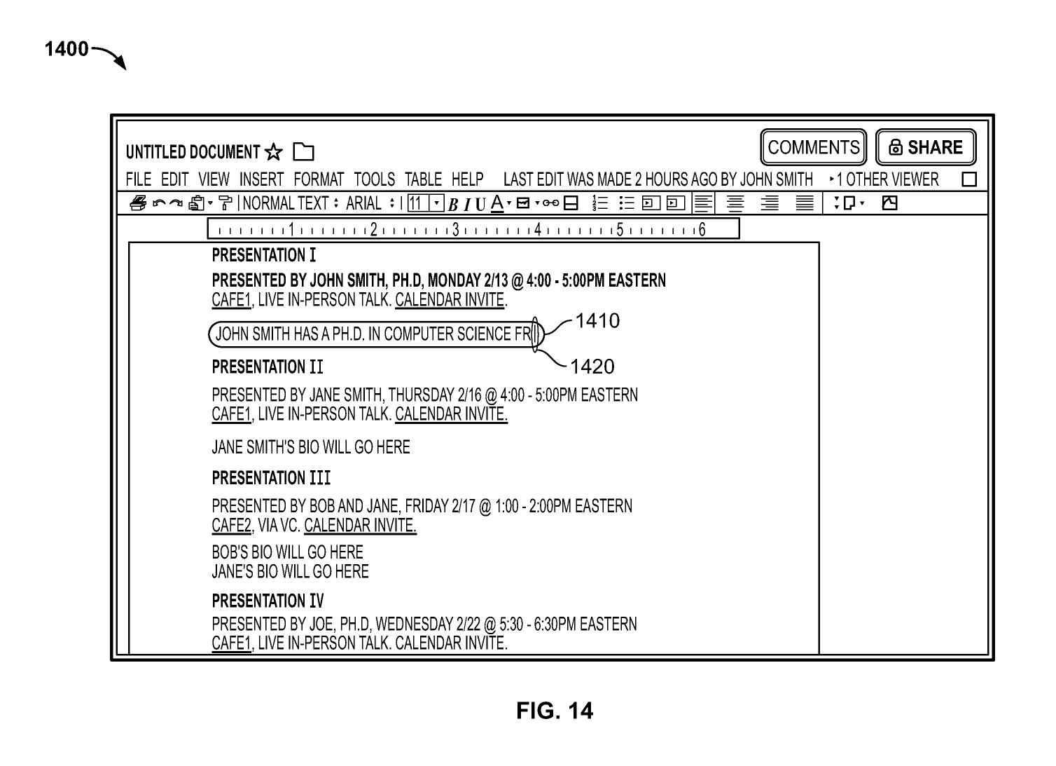

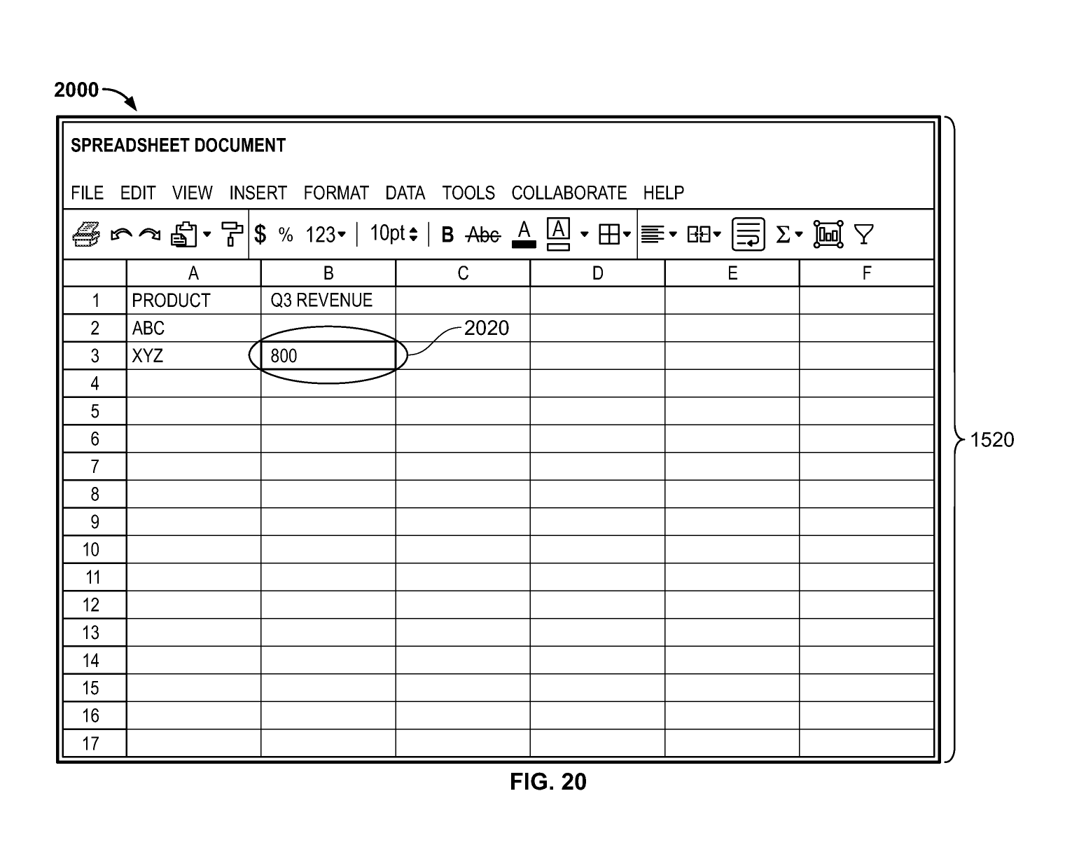

At step 528, the electronic document is updated with the one or more modifications received from the second user. In some implementations, the updates to the electronic document are made in real time. FIGS. 14 and 20 show the updates to the electronic document when the electronic document is a text document and a spreadsheet document, respectively.

FIG. 14 shows an exemplary display of a modification 1410 of a text document, similar to the text document 820 shown in FIG. 8, as seen by the first user. FIG. 14 shows an exemplary browser-based interface 1400 for accessing a text document. The browser-based interface 1400 may be similar to the browser-based interface 800 shown in FIG. 8. FIG. 14 displays an example modification 1410 of a text document. The modification 1410, in this example, corresponds to the modification 1310 of FIG. 13 made by the second user at step 526 of FIG. 5. A cursor 1420 indicates the location of the second user's input entry point within a selected sub-section of the electronic document. Each user may have a different cursor location and may be represented by a different cursor within the browser-based interface. The cursor 1420 may move in real time to display the modifications as they are made by the second user from within a notification message. In some implementations, the second user may make the modification from a browser-based interface which may be used for accessing a selected sub-section of the document via a URL. The modification 1410 is an example of an inline modification. Inline modification herein includes modification of the text of the text document. Inline modifications may be displayed as text added, inserted, replaced, and/or deleted from the document. In some implementations modifications may be displayed as comments. Comment herein includes text indicative of the modification, user ID of user making modification, time of modification, and/or other related information. Comment modifications may not modify the text of the text document and may be displayed on the sidebar of the document.

FIG. 20 shows an exemplary display of a modification 2020 of a spreadsheet document, similar to the spreadsheet document 1520 shown in FIG. 15, as seen by the first user. FIG. 20 shows an exemplary browser-based interface 2000 for accessing a spreadsheet document. The browser-based interface 2000 may be similar to the browser-based interface 1500 shown in FIG. 15. The modification 2020, in this example, corresponds to the modification 1920 of FIG. 19 made by the second user at step 526 of FIG. 5. The modification 2020 is displayed in real time as the second user makes the modification from within a notification message. In some implementations, the second user may make the modification from a browser-based interface which may be used for accessing a selected sub-section of the document via a URL. The modification 2020 is an example of an inline modification. Inline modification herein includes modification of the content of a cell of a spreadsheet document. Inline modifications may be displayed as content added, inserted, replaced, and/or deleted from a cell of a spreadsheet document. In some implementations modifications may be displayed as comments. Comment herein includes text indicative of the modification, user ID of user making modification, time of modification, and/or other related information. Comment modifications may not modify the content of a cell of a spreadsheet document and may be displayed as a note, comment, a pop up box, help text and/or other suitable display objects linked to a cell of a spreadsheet document. In some implementations, comments may be displayed on the side bar of a spreadsheet document.

FIG. 6 is a flowchart of a method 600 used by a server application similar to the server application 104 of FIG. 1 to manage the access level of a user similar to the second user of step 514 of FIG. 5.

At step 602, the server application determines the access level of a second user selected by a first user, similar to the first user of step 514, to modify an electronic document similar to the electronic document 108 of FIG. 1. This may be similar to step 518 of FIG. 5. In some implementations, the server application may bypass step 602 and proceed with step 612 of method 600.

At step 604, the access level determined at step 602 is used to decide whether the second user has the authority to modify the electronic document. In some implementations, the access level of the user can be one of editor, reviewer, or viewer depending on the user type entry in the data structure 210. In some implementations, the user may have access to modify the electronic document 108 if the user is listed as an editor user type in data structure 210. In some implementations, the user will have access to modify the electronic document 108 if the user is either listed as a reviewer user type or listed as an editor user type in the data structure 210.

If the second user does not have the authority to modify the electronic document, then at 608, the user ID of the second user is checked against a user blacklist. The user blacklist can be stored in the electronic database 106 of FIG. 1, the memory unit of the server application 104, and/or any suitable electronic storage location accessible to the server application 104. If the blacklist includes the user ID of the second user, then at 610, a message is sent to the first user informing the first user that his or her request that the second user edit the document is denied. If the blacklist does not comprise the user ID of the second user, then the second user's access level is promoted at 608. Promotion of a user herein means changing the user type of the user in data structure 210, such that the user will have lesser restrictions on accessing the electronic document 108. In some implementations a user with user type as viewer can be promoted to have a reviewer user type or an editor user type. In some implementations a user with a reviewer user type can be promoted to have an editor user type.

At step 612, a notification message is transmitted to the second user selected to modify a sub-section of the electronic document. Step 612 may be similar to step 522 of FIG. 5. In some implementations, the notification message may comprise a user-selectable option. The user-selectable option may be used by the second user to confirm and/or submit a modification of a selection of a sub-section of an electronic document. At 614, it is determined whether the notification message comprises a user-selectable option.

If the notification message does include a user-selectable option then the server application executes step 616. At step 616, the server application 104 receives a selection of the user-selectable option comprised in the notification message. In some implementations, the user-selectable option may be a submit button, similar to submit button 1910 of FIG. 19.

FIG. 19 shows an exemplary notification message with a user-selectable option 1910. In some implementations, the second user of step 514 of FIG. 5 may select the user-selectable option to confirm and/or submit the modification to a server similar to the server 102 of FIG. 1. A user may select the user-selectable option using an input device such as a mouse, keyboard, touchpad, trackball, joystick, and/or other suitable input devices.

If the notification message does not include a user-selectable option, then the server application executes step 618 to receive modification of a selection of a sub-section of an electronic document in real time. Real time herein means when the second user modifies a selected sub-section of an electronic document from a notification message or a browser-based interface, the first user viewing the electronic document almost immediately sees the modifications made to the electronic document. Step 618 may be similar to step 526 of FIG. 5.

FIG. 7 is a flowchart for a method 700 used by a server application, similar to the server application 104 of FIG. 1, to manage the updates to an electronic document.

At step 702, the server application may receive data indicative of the modification to the electronic document from a contributing user, such as the second user whose input is requested by the first user at step 514 of FIG. 5. Step 702 may be similar to step 526 of FIG. 5.

At 704, the server application decides whether the access level of the second user is that of an editor user type. If the user has editor user type then the server application updates the electronic document by modifying the content of the electronic document inline at step 708. Inline herein means that the original content of a selected sub-section of the electronic document may be replaced with the modified content as received in step 702. In some implementations, the server application may update the electronic document by modifying the content of the electronic document inline without considering the access level of the second user.

Otherwise the server application may modify the content of the electronic document with comments, suggested edits, and/or other suitable modifications supported by the server application at step 706. In some implementations modifications may be displayed as comments. Comment herein includes text indicative of the modification, user ID of user making modification, time of modification, and/or other related information. Comment modifications may not modify the content of the electronic document and may be displayed on the sidebar of the document

While various embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A method for interactively collaborating on an electronic document between a first user and a second user, comprising:
receiving a selection by the first user of a portion of the electronic document;
receiving a request from the first user that a second user edit the selected portion of the electronic document;
determining an access level of the second user;
in response to the request, transmitting a notification message to the second user, wherein the notification message includes the selected portion of the electronic document;
receiving from the second user, a modification of the selected portion of the electronic document via the notification message; and
updating the electronic document with the modification of the selected portion of the electronic document.

2. The method of claim 1, wherein the updating of the electronic document is performed in real time.

3. The method of claim 1, further comprising:
receiving a selection by the second user of a user-selectable option in the notification message;
in response to the selection of the user-selectable option, updating the electronic document with the modified selected portion of the electronic document.

4. The method of claim 1, wherein the first user has a first access level for the electronic document and the second user has a second access level for the electronic document, the method further comprising promoting the second user to a third access level for the electronic document in response to the request for an edit by the first user.

5. The method of claim 1 wherein the access level for the electronic document comprises one of the group of: editor, reviewer, and viewer.

6. The method of claim 1, wherein the updating of the electronic document with the modification of the selected portion of the electronic document is based on the access level of the second user.

7. The method of claim 6, wherein the updating the electronic document comprises inserting the modification of the selected portion of the electronic document as a comment.

8. The method of claim 6, wherein the updating the electronic document comprises inserting the modification of the selected portion of the electronic document as an inline modification.

9. The method of claim 1, wherein the electronic document comprises one of the group of: a text document, a spreadsheet, a presentation, a form, a table, and a drawing.

10. The method of claim 1, wherein the selected portion comprises one of the group of: a spreadsheet cell, an object, an electronic document text, a table row, a form input, and a slide.

11. A system for interactively collaborating on an electronic document between a first user and a second user, comprising a processor configured to:
receive a selection by the first user of a portion of the electronic document;
receive a request from the first user that a second user edit the selected portion of the electronic document;
determine an access level of the second user;
in response to the request, transmit a notification message to the second user, wherein the notification message includes the selected portion of the electronic document;
receive from the second user, a modification of the selected portion of the electronic document via the notification message; and
update the electronic document with the modification of the selected portion of the electronic document.

12. The system of claim 11, wherein the processor is configured to update the electronic document is in real time.

13. The system of claim 11, wherein the processor is further configured to:
receive a selection by the second user of a user-selectable option in the notification message;
in response to the selection of the user-selectable option, update the electronic document with the modified selected portion of the electronic document.

14. The system of claim 11, wherein the first user has a first access level for the electronic document and the second user has a second access level for the electronic document, the method further comprising promoting the second user to a third access level for the electronic document in response to the request for an edit by the first user.

15. The system of claim 11, wherein the access level for the electronic document comprises one of the group of: editor, reviewer, and viewer.

16. The system of claim 11, wherein the processor is configured to update the electronic document with the modification of the selected portion of the electronic document based on the access level of the second user.

17. The system of claim 16, wherein the processor is configured to update the electronic document by inserting the modification of the selected portion of the electronic document as a comment.

18. The system of claim 16, wherein the processor is configured to update the electronic document by inserting the modification of the selected portion of the electronic document as an inline modification.

19. The system of claim 11, wherein the electronic document comprises one of the group of:
a text document, a spreadsheet, a presentation, a form, a table, and a drawing.

20. The system of claim 11, wherein the selected portion comprises one of the group of: a spreadsheet cell, an object, an electronic document text, a table row, a form input, and a slide.

21. A non-transitory computer readable medium storing computer executable instructions, which, when executed by a processor, cause the processor to carry out a method for interactively collaborating on an electronic document between a first user and a second user, comprising:
receiving a selection by the first user of a portion of the electronic document;
receiving a request from the first user that a second user edit the selected portion of the electronic document;
determining an access level of the second user;
in response to the request, transmitting a notification message to the second user, wherein the notification message includes the selected portion of the electronic document;
receiving from the second user, a modification of the selected portion of the electronic document via the notification message; and
updating the electronic document with the modification of the selected portion of the electronic document.

22. The non-transitory computer readable medium of claim 21, wherein the method further comprising:
receiving a selection by the second user of a user-selectable option in the notification message;
in response to the selection of the user-selectable option, updating the electronic document with the modified selected portion of the electronic document.

23. The non-transitory computer readable medium of claim 21, wherein the first user has a first access level for the electronic document and the second user has a second access level for the electronic document, the method further comprising promoting the second user to a third access level for the electronic document in response to the request for an edit by the first user.
